(19) United States
(12) Patent Application Publication
(10) Pub. No.: US 2017/0202199 A1
(43) Pub. Date: Jul. 20, 2017

(54) SYSTEM FOR ATTRACTING FLYING INSECTS AND ARACHNIDS

(71) Applicant: BIOCARE Gesellschaft für biologische Schutzmittel mbH, Einbeck (DE)

(72) Inventor: Anant PATEL, Bielefeld (DE)

(21) Appl. No.: 15/125,260

(22) PCT Filed: Mar. 12, 2015
(86) PCT No.: PCT/EP2015/055133

§ 371 Date: Sep. 12, 2016

(30) Foreign Application Priority Data
Mar. 12, 2014 (DE) 10 2014 103 268.3

(51) Int. Cl. A01M 1/02; A01M 1/20

(52) U.S. Cl. CPC A01M 1/023; A01M 1/2016; A01M 1/2011

(57) ABSTRACT

The invention relates to a system or device for attracting and optionally killing flying insects end arachnids. The system or device according to the invention comprises microorganisms which release CO₂, nutrients specific for these microorganisms, and biodegradable biopolymers, wherein said system is designed in such a way that these biodegradable biopolymers include or comprise the further constituents mentioned above. The system or the device maybe designed in such a way that the system or device releases CO₂ over a time period of more than 20 days in order to attract the flying insects and arachnids. The invention further relates to the use of a such a system or such a device for attracting flying insects and arachnids. Finally, the invention also relates to methods for attracting and optionally killing such flying insects and arachnids, wherein the systems or devices according to the invention are placed appropriately, in order to attract said insects and arachnids by means of a CO₂ gradient.

This invention relates to a system or device for attracting and optionally killing flying insects and arachnids. The system or device according to the invention comprises microorganisms that release CO₂, nutrients specific for these microorganisms, and biodegradable biopolymers, wherein this system is configured in such a way that these biodegradable biopolymers embed or envelop the other constituents, in particular the ones mentioned above. The system or device can be configured in such a way that it releases CO₂ over a period of more than 20 days in order to attract the flying insects and arachnids.

This application furthermore provides the use of such a system or device for attracting flying insects and arachnids. Lastly, this application also relates to methods for attracting and optionally killing these flying insects and arachnids, wherein the systems or devices according to the invention are placed in an appropriate manner for attracting, and optionally killing, said insects and arachnids by means of a CO₂ gradient.

### PRIOR ART

The use of carbon dioxide (CO₂) as an attractant for soil-dwelling organisms has been described. Many soil pests use CO₂ and the concentration thereof for finding their hosts. A frequently described example of such is the western corn rootworm (Diabrotica virgifera virgifera), whose larvae use CO₂ for finding the roots of living corn plants in order to use them as food. Because corn plants release CO₂, the CO₂ concentration is greater at or in the vicinity of the plants or plant roots than in more remote areas, hence the larvae move in the direction of the ascending CO₂ gradient.

The destruction of the roots and the accompanying physiological stressing of the plants by the feeding behavior of the larvae lead to heavy losses in crop plants.

Various attractant systems and bait traps have been described for such soil pests. Along with various standard chemical or biological pesticides, attempts have been made to disrupt host location by these pests, which, as already mentioned, is accomplished by means of an ascending CO₂ gradient. Various possibilities for disrupting host location are described by E. A. Bernklau et al. (see for example Bernklau, E. A. et al., Journal of Economic Entomology, 97(2), 330-339, 2004). Methods and devices for attracting pests are mentioned in this document. It describes granules composed of baker's yeast, yeast nutrients, and an organic substrate, which then serve as a CO₂ source in order to keep the larvae of the western corn rootworm away from the roots of corn plants. Similar methods are disclosed by Bernklau et al. in patent applications WO 01/32013 A1 and U.S. Pat. No. 6,978,572 B1. Formulations comprising inter alia a CO₂-releasing agent such as yeast, yeast nutrients, and a polymer are described in these documents. Granules in which the polymer serves as a matrix are produced. This matrix formed from the polymer is described in particular as having a spongiform or porous structure. Such a structure supposedly allows a prolonged release of CO₂.

However, all of the devices and methods described have the problem that they enable the formation of a CO₂ gradient, and hence the efficacy of the system, only for pests that live in and/or on the soil and only for a short while. Time periods of 2 weeks maximum are described for the established methods.

There are no commercial CO₂-based techniques and methods for air-based systems, in other words attractant systems that work in gas-filled spaces and in open air rather than in the soil, in particular systems designed to attract flying insects and arachnids. R. C. Smallegange et al. (Malaria Journal 2010, 9, 292) recently described how a mixture of yeast, sugar solution, and water in mosquito traps is able to attract mosquitos. However, it was shown that a CO₂ gradient was only formed for a short while. A considerable decline in CO₂ production by the yeast was observed after only 34 hours. The system described therein is also hard to manage and poses a considerable contamination hazard.

The object of the present invention is to provide systems that enable the attraction and optionally trapping and ultimately killing of flying insects and arachnids. Another object is to provide appropriate methods for controlling these flying insects and arachnids as well as the use of systems for controlling these animals. The systems and devices of the invention enable the control of aerial pests, in particular of flying insects and arachnids that are potential vectors of parasites. In the present case, “parasites” means micro- as well as macroparasites, in other words microorganisms (including eukaryotic and prokaryotic microorganisms such as bacteria, protozoa, and fungi) as well as viruses, etc.

The systems or devices of the invention are particularly suitable for controlling not only parasite-transmitting flying insects such as mosquitoes, tsetse flies, etc. but also arachnids such as ticks and mites, etc.

### DESCRIPTION OF THE INVENTION

According to the invention, provision is made of a system or device for attracting and optionally trapping and ultimately optionally killing flying insects (Pterygota) and arachnids (Arachnida), comprising CO₂-relasing microorgnisms, nutrients specific for these microorganisms, and a biodegradable biopolymer. The biodegradable biopolymer is configured in such a way that it embeds or envelops the other constituents, in particular the ones mentioned above, for example in the form of capsules, granules, particles, strips, coatings, fibers, etc. In one embodiment, the system or this device releases CO₂ over a period of more than 20 days in order to attract the flying insects or arachnids. In one embodiment, the biopolymer can completely envelop the other constituents.

It is possible for the release of CO2 to take place over a period of more than 20 days, such as more than 25 days or over 28 days and longer, for example up to 35 days and more.

In the present case, the terms “system” and “device” shall be used synonymously unless stated otherwise.

In the present case, the expression “over a period of more than 20 days” means that the CO₂-releasing microorgnisms in the system of the invention actively release CO₂ over a period of more than 20 days. This means that at least portions of the microorganisms in the system remain alive over said period and are actively releasing CO₂. This means in particular that the CO₂ concentration in the immediate vicinity of the system is above (higher than) the CO₂ concentration of a region more remote from the system, hence a CO₂ gradient is formed in the direction of the system.

Surprisingly, it turns out that a CO₂ gradient is also formed for systems and devices in the open air, i.e., in a gaseous environment.

According to the invention, the system or device is one formed of capsules, optionally also pellets or granules, in which at least the capsule shell or capsule matrix is formed from one or more biopolymers. These matrices can be ones that completely contain biopolymer, for example in the form of pellets. In one embodiment, the pellets or capsules can essentially be completely enclosed by the biopolymer. This means that the biodegradable polymer forms a system that embeds or envelops said other constituents such as microorganisms and nutrients for the microorganisms. These can also be granules, wherein these granules have one or more biopolymers that likewise enclose the other constituents, preferably completely so that they cannot escape from the system or device, or serve as a crosslinking and stabilizing matrix. Also possible are embodiments of the system according to the invention in which the biopolymers infuse the particles, capsules, pellets or granules of the other constituents and thus provide the necessary stability of the system. The systems and devices can be configured in such a way that gaseous substances such as CO₂ are released, whereas solid and liquid substances remain in the system or device.

Other forms include: strips, fibers, or coatings. Depending on the particular application, coatings can be applied to different substrates such as gratings or collars (e.g., tick collars), but also generally in the form of particles, etc. Structures suitable for coating are known to those skilled in the art.

The systems or device in the form of corresponding particles, capsules, pellets, or granules can furthermore have surface coatings or surface deposits in general of insecticides and/or acaricides, which can trap and optionally kill the flying insects and arachnids to be attracted. The surface of the systems and devices according to the invention can also have other constituents for trapping the attracted flying insects and arachnids, for example adhesive constituents for trapping said flying insects and arachnids.

In the present case, the terms “insecticides” and “acaricides” mean active ingredients that can paralyze and optionally kill said flying insects (insecticides) and/or arachnids (acaricides).

Hence in one embodiment, insecticides and/or acaricides are present in the system of the invention or device of the invention, in particular ones chosen from the group of chemical insecticides, chemical acaricides, plant extracts, and entomopathogenic microorganisms. These insecticides and acaricides, respectively, have specific action against certain flying insects such as mosquitos, flies, etc. or arachnids such as ticks, etc., which are capable of transmitting parasites to humans in particular but also to animals.

The CO₂-releasing microorganisms present in the system are in particular fungi or bacteria. The microorganisms are preferably yeasts, including commercially available yeasts such as baker's yeast but also residual yeast from beer, wine, and bioethanol production. One or several different microorganisms that also release CO₂ and/or have auxiliary functions may be present.

In one embodiment, at least a second microorganism (also designated as a helper organism) can be one with insecticidal or acaricidal activity. Suitable microorganisms are known to those skilled in the art. These can include, for example, a second microorganism with entomopathogenic activity. in the present case, “entomopathogenic” means that the microorganism has the capacity to infect, kill, trap, or otherwise render insects and/or arachnids harmless.

In one embodiment, at least a second microorganism may be present that helps supply nutrients to the CO₂-releasing microorganisms. Examples of such include nutrient-mobilizing microorganisms. These microorganisms provide a carbon source and/or nitrogen source (C-source and/or N-source) for the CO₂-releasing microorganisms. An example of such is the fungus Beauveria bassiana. This fungus is known for parasitizing various arthropod species. It is also known as a biological insecticide. As an alternative, it has also been shown that a fungus in the genus Metarhizium, namely M. anisopliae, can convert nutrients present in the system in such a way that they can be better metabolized by the microorganisms responsible for CO₂ production.

In the present case, “second organism” or “helper organism” means not only the entire living microorganism, but also individual enzymes or blends of enzymes.

For example, said fungi B. bassiana and M. anisopliae enable a breakdown of starch, which is present as a special nutrient for the microorganism in the system. Said fungi have amylase activity and are thus able to break down the starch accordingly. In one embodiment there is thus a second microorganism, also referred to as a helper organism, which has amylase activity and is able to break down nutrients in the form of starch, for example, so that they are available to the CO₂-releasing microorganisms. In the present case, B. bassiana and M. anisopliae are thus able to perform two functions. On the one hand they have insecticidal or acaricidal activity. On the other hand they permit the conversion of nutrients in order to make the latter more easily metabolizable for the microorganisms responsible for releasing CO₂, for example by virtue of said amylase activity in these microorganisms.

It is furthermore possible for individual enzymes (e.g., amylases or other glycosidases, proteases, etc.) rather than entire helper organisms to be present as constituents of the system of the invention or device of the invention.

The specific nutrients for these microorganisms can be those chosen from cereal flour, corn flour, corn protein and other corn constituents, starch, cucurbitacin, potato flour, for example. However, use can also be made of raw materials and residue materials from the agri-food industry. If for example use is made of cellulose, then cellulase or cellulase-containing microorganisms are used as helper organisms or additives.

Nutrients otherwise suited for the microorganisms present in the system are known to those skilled in the art. These nutrients are not only ones that are converted to CO₂ but also ones that the microorganisms need to survive, including N-sources, etc.

The flying insects are in particular those in the taxa Diptera, Neoptera, Hymenoptera, Coleoptera, and Heteroptera, in particular flies, mosquitos, true bugs, and termites. The system is in particular suitable for attracting flying insects such as tsetse flies, mosquitos, etc., that are or that may be infected with parasites. In a preferred embodiment, the arachnids are mites and ticks.

As already mentioned, the system or device in one embodiment is one that additionally has an insecticide and/or an acaricide. This insecticide and/or acaricide can be a chemical or botanical insecticide and/or chemical or botanical acaricide, but also ones such as the aforementioned entomopathogenic fungi, etc.

It has been shown that the system of the invention or device of the invention in the form of, for example, capsules or pellets that contain yeast, corn meal or other starch sources, and helper organisms such as B. bassiana or M. anisopliae, is conducive to the desired characteristics of generating a CO₂ concentration appropriate for attracting flying insects and arachnids in gaseous environments, for example in the air.

Accordingly, the systems or devices according to the invention can be used to attract and optionally trap and optionally kill flying insects and arachnids. For example, these systems can be positioned near windows and doors in order to catch flying insects or arachnids entering enclosed spaces or buildings. For example, these systems or devices for attracting these flying insects and arachnids can be arranged on or integrated in screens and mosquito netting in order to attract and trap said flying insects and/or arachnids. Such systems and devices are particularly suitable in regions where humans are at risk of coming into contact with flying insects or arachnids that are or may be infected with parasites and being bitten by the same. The present system or device can be easily and economically produced and deployed. This system is thus especially well-suited for low-income regions such as ones in Africa, Asia, etc. For example, the system according to the invention can be used to control tsetse flies, which are vectors of malaria. The systems according to the invention can be used in prior art attractant systems. Owing to the embedding or enveloping biopolymer, there is little risk of any hazard being posed to humans or animals through coming into contact with the system, and the exposure of humans or animals to hazardous materials such as insecticides is reduced.

The system can furthermore have additional constituents such as fillers, desiccants, glucose, sucrose, and other attractants such as isolates from human sweat, feathers, horse hairs, or other known chemical attractants for the respective flying insects and/or arachnids. Furthermore, cellulose, lignin and/or swelling agents can also be present. Suitable other constituents are known to those skilled in the art, wherein these other constituents do not interact with the microorganisms in the system in such a way that these microorganisms in the system are killed or otherwise impaired in performing their function.

The systems according to the invention are characterized in that they have one or several biodegradable biopolymers. These biopolymers embed or envelop the microorganisms and nutrients and form a capsule shell, for example, if the system is completely enclosed in the form of a capsule. These capsule shells can be configured in such a way that they enable an exchange of nutrients and in particular release of CO₂, in other words gaseous constituents can pass through the capsule shell but liquid or solid constituents cannot.

In an alternative embodiment, the system of the invention is one in which the biopolymer forms a matrix. The rest of the constituents are embedded in the matrix or the matrix envelops the constituents, wherein the envelopment can be a partial or a complete envelopment. These matrices are configured such that the biopolymers in one embodiment preferably envelop the other constituents substantially, preferably completely.

The biodegradable biopolymer is in particular one selected from alginate, carrageenan, cellulose, hemicellulose, starch, chitin, chitosan, pectinate, guar gum, acacia gum, poly(D,L-lactic acid), gelatin, polyamino acids, lignin, and derivatives as well as mixtures thereof. Suitable biopolymers are known to those skilled in the art. For example, use can be made of alginate or of an alginate-gelatin mixture.

However, the systems and devices according to the invention can also be ones in which the capsule-forming polymers are, at least partially, non-biodegradable polymers. Nevertheless the polymers still have to fulfill the requirements of being permeable to CO₂ and optionally to other gaseous constituents so that the microorganisms present in the system can release CO₂ over a prolonged time period in order to attract and optionally trap said flying insects and arachnids.

This application furthermore relates to the use of a system according to the invention or device according to the invention for attracting and optionally trapping and optionally ultimately killing flying insects (Pterygota) and/or arachnids (Arachnida), in particular for attracting and killing flying insects and arachnids that are potential parasite vectors.

Particular preference is given to using the system according to the invention or device according to the invention for controlling flying insects that are potential parasite vectors in rooms, including tents, or in enclosed areas in general. For example, the method of the invention is suited for use in controlling not only flying insects such as tsetse flies and mosquitos, but also ticks, etc. However, it is also possible to use the system of the invention or device of the invention outside of rooms, in other words outdoors (in forests, for example) in order to control flying insects or pests capable of flight in general. The system is suitable for controlling insects and arachnids that that are potential parasite vectors, wherein the parasites are, inter alia, ones capable of infecting and infesting animals such as mammals. As examples, mention is made here of livestock and here in particular farm animals, including poultry and cattle, goats, sheep, etc.

The system is preferably one that also traps the flying insects and/or arachnids, also known as “attract and trap”, and ultimately kills them, generally known as the “attract and kill” approach. In addition to the CO₂-releasing microorganisms, the systems can therefore contain other microorganisms that have insecticidal or acaricidal activity and/or that help supply the CO₂-releasing microorganisms with nutrients by breaking down these nutrients by virtue of, for example, amylase activity. Known materials that bring about the death of the attracted insects and arachnids can also be present.

Accordingly, the systems can furthermore have suitable botanical or chemical active ingredients for killing the flying insects and arachnids.

Lastly, according to the invention provision is made of methods for attracting and optionally trapping and killing these flying insects and arachnids. This method comprises the corresponding provision of a system of the invention or device of the invention and positioning the latter in such a way that the flying insects and/or arachnids are attracted. Appropriate positioning comprises a positioning in entry areas of buildings or enclosed areas. These systems or devices can be provided with corresponding mechanisms such as screens or mosquito netting etc. in order to attract and optionally kill the flying insects and arachnids.

Options and mechanisms suitable for carrying out the method are known to those skilled in the art.

The method of the invention is in particular one that is characterized in that the flying insects and arachnids are attracted toward the system or device of the invention by an elevated CO₂ concentration in and in the vicinity of said system or device of the invention, in order to be trapped and optionally killed there. The method is suited in particular for attracting and killing these flying insects and arachnids over a long time period. In one embodiment, this time period is at least one of 20 days, preferably at least 25 days, for example at least 30 days.

Particularly suitable embodiments are ones with capsules or pellets comprising a biopolymer or biopolymer blend, at least one CO₂-releasing microorganism such as a yeast, nutrients such as starch-containing nutrients, and helper microorganisms such as B. bassiana or M. anisopliae, or enzymes and optionally other kill components.

The systems and devices according to the invention can have other attractants, which attract the flying insects and arachnids along with or in addition to CO₂. These attractants are in particular ones that attract the flying insects and/or arachnids in the direction of the system from a short distance so that they can optionally be killed there.

The system according to the invention and the use according to the invention will be explained in more detail in the following, without being limited thereto.

### EXAMPLES

### Example 1

### Formulation of the System According to the Invention

A predetermined quantity of S. cervisiae, either as a cultured strain or as a commercially available baker's yeast mix, is suspended, optionally with the other constituents such as starch and/or helper microorganisms such as Beauveria bassiana or M. anisapliae, or enzymes such as amylase, in 2% sodium alginate and, using a standard encapsulation device, added dropwise to a 2% CaCl₂ solution and cross-linked for 20 minutes. The capsules were made with an average diameter of 2.7 mm.

### Example 2

### Use of the System According to the Invention for Attracting and Optionally Trapping Ticks

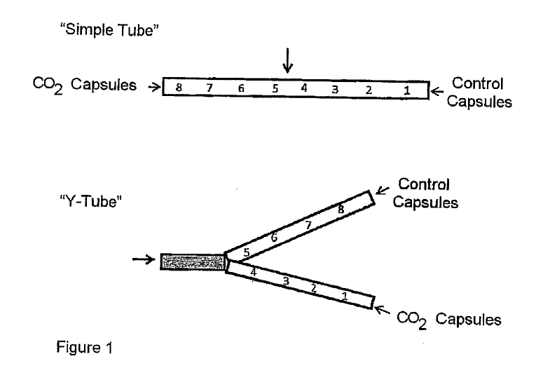

Ticks (Ixodes ricinus) were introduced into a simple tube or a Y-shaped tube at the position of the arrow, FIG. 1. The numbers indicate the sampling point of the CO₂ measurement.

After waiting 24 hours, the sector in which the ticks congregated was determined. In this process the capsules were always placed at the end of the tube. The results of 2 experiments (trials) are given in Table 1 and in Table 2. The CO₂ gradient from position 8 to 1 and from position 8 to 5 (Y-tube) is also represented.

TABLE 1
Simple tube

| | | CO₂ | Control | | |
|---|---|---|---|---|---|
| Trial | No. ticks | side | side | Junction | Gradient |
| 1 | 12 | 9 | 2 | 1 | 890-740 ppm |
| 2 | 11 | 8 | 2 | 1 | 840-800 ppm |

TABLE 2
Y-tube

| | No. | CO₂ | Control | | Initial | |
|---|---|---|---|---|---|---|
| Trial | ticks | side | side | Junction | tube | Gradient |
| 1 | 19 | 12 | 2 | 2 | 3 | 890-740 ppm |
| 2 | 19 | 8 | 2 | 1 | 8 | 620-510 ppm |

It can be clearly discerned that the ticks move in the direction of the CO₂-releasing capsules, in the direction of the ascending CO₂ gradient.

A kill trial was also conducted using the beneficial fungus M. anisopliae as a kill component. For this purpose, the tick nymphs were immersed for 30 seconds in a fungal spore suspension (1%) or in water as a control, respectively. While the ticks were still vital several days after the control treatment, 50% of the ticks treated with the fungal spore suspension had died, and the rest showed only little vitality. Fungi grew out of the dead ticks plated out on selective agar.

Hence a relatively slight CO₂ gradient is sufficient for attracting ticks. In addition to its capacity to convert, by virtue of its amylase, nutrients present in the capsules in the form of starch in order to provide food for the yeast, the fungus M. anisopliae is suitable as a kill component.

### Example 3

Use of the system according to the invention for attracting and optionally trapping the common house mosquito (Culex pipiens)

Adult mosquitos were introduced into a simple tube similar to the one shown in FIG. 1. The CO₂-releasing capsules and the control capsules, respectively, were placed at the ends. The CO₂-releasing capsules were ones with baker's yeast (16.7 wt %), starch (20 wt %), amylase (0.5 U/g of capsule).

Air was fanned from the ends of the tubes toward the center. The results of a trial after one day are given in Table 3.

TABLE 3

| | | | Control | |
|---|---|---|---|---|
| Trial | No. mosquitos | CO₂ side | side | Junction |
| 1 | 11 | 9 | 1 | 1 |

It was shown that even with a slight CO₂ gradient, the mosquitos also move in the direction of the ascending CO₂ gradient and can thus be attracted successfully.

1. A system or device for attracting and optionally killing flying insects (Pterygota) and arachnids (Arachnida), comprising
CO2-releasing microorganisms,
nutrients specific for said microorganisms, and
a biodegradable biopolymer, wherein said biodegradable biopolymer embeds or envelops said CO2-releasing microorganisms and nutrients specific for the microorganisms.

2. The system or device as claimed in claim 1, wherein said system or device is configured to release CO2 over a period of more than 20 days in order to attract the flying insects and arachnids.

3. The system or device as claimed in claim 1, wherein the CO2-releasing microorganisms are chosen from fungi or bacteria and yeast.

4. The system or device as claimed in claim 1, wherein said nutrients are chosen from one or more of cereal flour, corn flour, corn protein and other corn constituents, starch, cucurbitacin, potato flour, raw materials and residual materials from the agri-food industry, and cellulose.

5. The system or device as claimed in claim 1, wherein said system or device is configured for attracting flying insects and including one or more of Diptera, Neoptera, Hymenoptera, Coleoptera, and Heteroptera.

6. The system or device as claimed in claim 1, wherein said system or device is configured for attracting arachnids.

7. The system or device as claimed in claim 1, further comprising one or more of an insecticide and an acaricide.

8. The system or device as claimed in claim 1, wherein said system or device further comprises one or more of enzymes, fillers, desiccants, glucose, sucrose, isolates of human sweat, feathers, horse hairs, cellulose, lignin and/or swelling agents in the biodegradable biopolymer.

9. The system or device as claimed in claim 1, wherein said biodegradable biopolymers is chosen from alginate, carrageenan, cellulose, hemicellulose, starch, chitin, chitosan, pectinate, guar gum, acacia gum, poly(D, L-lactic acid), gelatin, polyamino acids, lignin, and derivatives as well as mixtures thereof.

10. The system or device as claimed in claim 1, wherein said system or device is configured in the form of capsules, pellets, granules, particles, strips, fibers, or coatings.

11. The system or device as claimed in claim 1, further comprising one or more of helper microorganisms and enzymes that help supply nutrients to the CO2-releasing microorganisms.

12. The system or device as claimed in claim 11, wherein one or more of the following applies
said helper organisms are fungi, and
said helper organisms and/or enzymes have amylase activity.

13. The use of a system or device as claimed in claim 1 for attracting flying insects and arachnids that are vectors of parasites.

14. A method for attracting and optionally killing one or more of flying insects and arachnids, comprising
providing a system or device comprising
CO2-releasing microorganisms,
nutrients specific for the microorganisms, and
a biodegradable biopolymer, wherein this biodegradable biopolymer embeds or envelops the CO2-releasing microorganisms and nutrients specific for the microorganisms; and
positioning said system or device in such a way that the one or more of flying insects and arachnids are attracted.

15. The method as claimed in claim 14, wherein said method further comprises trapping one or more of flying insects and arachnids.

16. The system or device as claimed in claim 3, wherein the CO2-releasing microorganisms are baker's yeast.

17. The system or device as claimed in claim 5, wherein said system or device is configured for attracting flying insects including one or more of flies, mosquitos, true bugs, and termites.

18. The system or device as claimed in claim 6, wherein said system or device is configured for attracting mites and ticks.

19. The system or device as claimed in claim 7, wherein the one or more of an insecticide and an acaricide are selected from the group consisting of chemical insecticides, chemical acaricides, plant extracts, and entomopathogenic microorganisms.

20. The system or device as claimed in claim 12, wherein said helper organisms are fungi selected from B. bassiana or M. anisopliae.
